(19) United States
(12) Patent Application Publication
(10) Pub. No.: US 2007/0233570 A1
(43) Pub. Date: Oct. 4, 2007

(54) REWARDS SCHEME

(75) Inventor: RANDALL DEER, Queensland (AU)

Correspondence Address: CANTOR COLBURN, LLP, 55 GRIFFIN ROAD SOUTH, BLOOMFIELD, CT, 06002, US

(73) Assignee: CORPREWARDS PTY LTD, Broadbeach QLD (AU)

(21) Appl. No.: 11/695,180

(22) Filed: Apr. 2, 2007

(30) Foreign Application Priority Data
Mar. 31, 2006 (AU) 2006201345

(51) Int. Cl. G06Q 30/00

(52) U.S. Cl. 705/14

(57) ABSTRACT

A loyalty rewards scheme in which a scheme provider secures a reduced rate for supplying goods or services from suppliers of goods or services; the scheme provider secures a business as a participant in the loyalty rewards scheme and the scheme is arranged such that a customer of the business obtains redeemable credits from the business when the customer purchases goods or services from the business in excess of a predetermined minimum amount, wherein the customer obtains goods or services from one or more of the suppliers and pays for those goods or services by a combination of money and redeemable credits.

### FIELD OF THE INVENTION

The present invention relates to a method for providing goods or services to a customer of a business. In another aspect, the present invention relates to a loyalty rewards scheme. In a further aspect, the present invention relates to a method for selling excess stock or excess service capacity.

### BRIEF DESCRIPTION OF THE INVENTION

In a first aspect, the present invention provides a method for providing goods or services to a customer of a business comprising:
a) approaching a plurality of suppliers of goods or services;
b) securing a reduced rate with each supplier of the plurality of suppliers for the supply of goods or services;
c) recording details of the suppliers and the rates at which the suppliers supply goods or services;
d) issuing redeemable credits to a customer of the business, the redeemable credits having a face value equivalent to a predetermined cash value; and
e) arranging supply of goods or services from one or more of the plurality of suppliers to the customer, the supply of goods or services being paid for by the customer by using a combination of money and the redeemable credits.

In one embodiment of the present invention, the plurality of suppliers of goods or services comprise suppliers of accommodation services. In this embodiment, the accommodation services may be secured at a rate that is lower than the cheapest advertised rate for each of the suppliers of the accommodation services. For example, a supplier of accommodation services may have a normal or peak rate of, say, $1,000 per week for provision of the accommodation services. In low periods, the accommodation rate may drop to $800 per week. These rates are publicised or advertised by the accommodation provider. However, for the purposes of the method of the present invention, the reduced rate at which the accommodation services are provided may be as low as $300 per week. Ideally, this reduced rate is made available in respect of accommodation that would otherwise be unused. In this regard, the accommodation may be considered to be excess accommodation. For example, in the low season, the typical occupancy rate of an accommodation supplier may be 30%, meaning that 70% of the rooms are normally empty (and therefore generating no income). Therefore, if this accommodation is made available at a rate of $300 per week, this represents an increase in revenue to the accommodation provider. Effectively, this represents incremental business for the supplier of the goods or services.

It will be understood that many accommodation providers are not typically willing to advertise such reduced rates for accommodation as it may have the effect of suppressing demand for their accommodation that is available at the regular rate (or, in other words, offering a normal discount would be seen to affect the price integrity of the supplier's goods or services). In some embodiments, the present invention recognises this and overcomes this hurdle by requiring that supply of the accommodation to a customer of the business requires payment in real money of at least the reduced rate. In addition, securing the accommodation also requires that the customer of the business redeem some of the redeemable credits that they have obtained by virtue of their custom at the business. The redeemable credits may bear a monetary face value that can be used to obtain accommodation from the accommodation providers. For example, if the redeemable credits are in the form of a voucher having a face value of $500, supply of accommodation in the low season may be promoted as requiring the use of a $500 redeemable accommodation voucher and $300 real money. Thus, the price of the accommodation can be advertised as being $800 per week, which is equivalent to the normal low rate of the accommodation provider. However, the customer of the business is required to spend only $300 of real money to obtain this accommodation, provided that a $500 redeemable voucher for the accommodation is also utilised. Thus, the customer has the perception that the value of the accommodation to that customer is $800 per week.

The customer may suitably obtain the redeemable credits by purchasing goods or services from the business or other activities that constitute “good behaviour” for that businesses customers. The redeemable credits may be obtained by spending in excess of a predetermined minimum amount with the business. The redeemable credits may increase if the customer spends an amount of money with the business that exceeds predetermined thresholds. For example, if a customer spends less than $200 with the business, the customer may obtain no redeemable credits. If a customer spends between $200 and $400 with a business, the customer may obtain a redeemable credit having a face value of $200. If the customer spends between $400 and $600 with the business, the customer may obtain a redeemable credit having a face value of $400, and so forth.

The method of the first aspect of the present invention suitably involves a third entity that negotiates and secures the reduced rate with each supplier for the supply of goods or services. The third entity may also negotiate with the business to provide the redeemable credits for customers of the business. In this regard, the third entity will undertake the following actions:
Negotiate the reduced rate for the supply of goods or services with the suppliers of the goods or services;
Complete contractual arrangements with the suppliers of the goods or services for supplying the goods or services at the reduced rate;
maintaining records of the suppliers of the goods or services, the quantity of the goods or services available to be supplied from each supplier, and the rate or dollar value for provision of the goods or services;
negotiate with the business for an appropriate scheme for issuing the redeemable credits. This will involve determining the minimum spend that customers of the business must make in order to qualify for obtaining redeemable credits and the manner of increasing the redeemable credits as spending of the customer with the business increases or other criteria that will reward good behaviour of the customer.

The method of the first aspect of the present invention may suitably include the steps of promoting or advertising the redeemable credits being obtainable by customers purchasing goods or services/spending money with the business, either through retail or closed user group/database communication initiatives.

In embodiments where a third entity is involved in the method of the first aspect of the present invention, the third entity may generate income from one or more of the following:
a) by receiving a payment from the business equivalent to a percentage of the redeemable value of the redeemable credits given by the business to its customers; or
b) by the third entity including a mark-up in the amount of real money that a customer must use to obtain supply of the goods or services. As an example, where the third entity negotiates an accommodation rate of $300 per week with an accommodation provider, the third entity may book that accommodation to a customer of the business by asking for payment of $350 in real money and $500 in redeemable credits or vouchers. The third party passes on $300 of the real money to the accommodation provider which is the rate at which the accommodation has been secured, whilst the third entity retains the $50 of real money that has been paid above the secured accommodation rate; or
c) by charging a fixed fee for currency packages; or
d) by charging separate design or printing fees.

In embodiments where a third entity secures reduced rates for supplying goods or services from the suppliers of those goods or services, the third entity suitably enters into contracts with suppliers that do not normally discount their rates to the levels that are given in this method or system. In this manner, the method is more attractive to the customers of the business because they can secure the goods or services from the suppliers of those goods or services at a rate that is much reduced compared to the normal rates.

Suitably, the third entity also enters into pricing integrity agreements with the suppliers of the goods or services such that the supplier of the goods or services cannot provide discounted rates except in conjunction with the third entity.

The present invention also provides a loyalty rewards scheme in which a scheme provider secures a reduced rate for supplying goods or services from suppliers of goods or services; the scheme provider secures a business as a participant in the loyalty rewards scheme and the scheme is arranged such that a customer of the business obtains redeemable credits from the business when the customer purchases goods or services from the business in excess of a predetermined minimum amount, wherein the customer obtains goods or services from one or more of the suppliers and pays for those goods or services by a combination of money and redeemable credits.

Suitably, the goods or services supplied by the suppliers of goods or services represent excess goods or excess service capacity.

In some embodiments, the redeemable credits have a face value equivalent to a monetary value. For example, the redeemable credits may be issued in the form of a voucher having an ascribed monetary value that can be used as part of a payment for the supply of goods or services from the suppliers of the goods or services.

Throughout this specification, the term “customer of a business” is to be given a broad meaning. In particular, the customer of a business includes typical customers who enter a business and purchase goods or services from that business. However, a customer of a business also includes a further business that stocks goods of the business for on-sale of those goods to others. For example, the first business may be a provider of goods to a retail department. The customers of that business may comprise the retail businesses that stock those goods. The first business may provide the redeemable credits to the retail business if the retail business meets certain sales targets or agrees to other requirements put forward by the first business, for example, positioning of products of the first business in high access areas or high visibility areas.

In a third aspect, the present invention provides a system for managing a rewards loyalty scheme as described herein, the system comprising a computer storage means for recording details of suppliers of goods or services under the loyalty rewards scheme, the computer storage means recording at least the rate at which the supplier suppliers goods or services and the availability of goods or services from the supplier, and a register for recording redemption of the redeemable credits.

The register for recording redemption of the redeemable credits may form part of the computer storage means.

The system may further include an issue register for recording issue of the redeemable credits. The issue register may record details of the customer (for example, name, address, telephone, email, other contact details) and the amount of redeemable credits issued to the customer. The issue register may also allow for accumulation of redeemable credits.

The system may further include a computer-enabled redemption request adapted to enable a customer to request a redemption, the computer-enabled redemption request including a field for entering details of one or more redeemable vouchers or credits to be redeemed by the redemption request. The redemption request may be used to pass information regarding the requested redemption onto the scheme provider and to enable the scheme provider to record details of the redeemable credits used in the redemption request. The scheme provider can also check that the redeemable credits are owned by the customer making the redemption request.

The system may include a facility to redeem credits by the customer entering web sites to enquire about availability, make an online booking or make an enquiry online about an online booking. This facility may also include a facility where redemption of the credits is reconciled against a customer's account.

### BRIEF DESCRIPTION OF THE DRAWINGS

FIG. 1 shows a flow sheet of part of an embodiment of the present invention;

FIG. 2 shows a flow sheet of another part of an embodiment of the present embodiment;

FIG. 3 shows a further flow sheet of yet another part of an embodiment of the present invention; and

FIG. 4 shows a sample redeemable voucher for use in embodiments of the present invention.

### DETAILED DESCRIPTION OF THE DRAWINGS

It will be appreciated that the attached drawings and the following description relate to preferred embodiments of the present invention. Thus, the present invention should not be considered to be restricted solely to those embodiments.

The embodiments shown in the drawings of the specification and the following description relate to embodiments of the invention in which a loyalty scheme provides access to accommodation, such as holiday accommodation, for customers of a business. However, it will be appreciated that the present invention should not be considered to be limited to this particular embodiment. The particular embodiment involves a scheme provider, in the form of an independent entity, negotiating and securing reduced rates of accommodation with one or more accommodation providers. The scheme provider also negotiates with one or more businesses to become business participants in the scheme. These businesses promote the loyalty scheme and provide redeemable credits, such as in the form of redeemable accommodation vouchers bearing a monetary face value, to customers or clients of those businesses. Customers or clients of the business may be eligible to receive the redeemable accommodation vouchers if they purchase goods or services from the business. There may be a predetermined minimum spend applicable before a customer or client becomes eligible to receive redeemable accommodation vouchers. The amount of vouchers issued to customers or clients may also depend upon the amount of spend that each customer or client has with the business. In one embodiment, the amount of accommodation vouchers given to each client may increase as the spend of each client with the business increases. The increase in the amount of the accommodation vouchers given to each client may increase in accordance with increases in spending that exceed one or more threshold values.

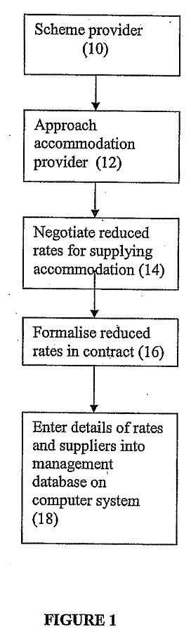

FIG. 1 shows a flow chart of part of a loyalty scheme in accordance with an embodiment of the present invention. In FIG. 1, a scheme provider 10 approaches a number of accommodation providers (at step 12). The scheme provider negotiates a reduced rate for supplying accommodation with each of the accommodation providers. This is shown at step 14. The reduced rate is formalised at step 16 in the form of contracts signed between the scheme provider and the accommodation providers. The scheme provider then enters details of the rates and accommodation suppliers onto a computer database at step 18. The computer database may be in the form of a spreadsheet or a structured database.

The flow sheet shown in FIG. 1 may include a number of options or variations. For example, at step 12, the scheme provider may approach the accommodation providers by way of forwarding initial correspondence, such as a letter or an email, outlining details of the scheme and explaining the benefits of the scheme to the accommodation providers. As the accommodation providers are being approached to provide accommodation at reduced rates, and even more suitably at substantially reduced rates, it is believed to be important that the accommodation providers be fully appraised as to the benefits accruing to them from participation in the scheme. The benefits for the accommodation providers arise by virtue of the fact that the reduced rates of accommodation are negotiated with the scheme provider in respect of rooms or accommodation that would typically be otherwise vacant. Thus, although the accommodation is provided by the accommodation provider at a rate that is substantially reduced compared to its normal rates and its other distribution channel rates, the reduced rate accommodation represents income that would otherwise not be generated. Thus, letting out those rooms at even the reduced rate of accommodation negotiated with the scheme provider represents an increase in marginal yield for the accommodation provider.

Many accommodation providers are reticent to promote such discounted rates of accommodation as they fear (often rightly so) that advertising those reduced rates will see a reduction in demand for accommodation provided at normal rates. However, the rewards scheme of the present invention addresses this issue and allows the accommodation providers to maintain price integrity over their accommodation. This will be described in more detail hereunder.

The accommodation providers also suitably enter into price integrity agreements with the scheme provider. Such agreements will require that the accommodation providers only provide accommodation at the discounted rate negotiated with the scheme provider to the scheme provider. Thus, people seeking to book accommodation with the accommodation providers through normal channels will only be offered normal accommodation rates by the accommodation providers. Such price integrity agreements have benefit for the accommodation providers and also maintain the benefits of the scheme to the scheme provider in that the reduced rate of accommodation is only available to customers who obtain benefits from participation in the scheme. The scheme provider may desirably require that the accommodation provider enters into an exclusive arrangement with the scheme provider so that the scheme provider does not supply their inventory to other similar programs.

The flow chart shown in FIG. 1 represents a typical starting point for the loyalty scheme in accordance with the present invention. In particular, the scheme provider seeks to build a resort base or accommodation provider base to make the scheme attractive to customers to the business participants in the scheme. To ensure that the resort base is attractive, the scheme provider will examine a number of issues associated with the resorts, including the quality of the resorts, the quality of the rooms available at the resorts, the number of rooms available, the locations of the resorts, the room rates, the cheapest accommodation rates advertised for each of the resorts and the facilities available at the resorts. Such investigations may typically occur by interrogating the website or home page for each resort or each accommodation provider or other holiday accommodation distribution sites. However, personal inspection or tours may also be used.

The scheme provider may also access information from last minute booking agents (for example, wotif.com.au) to see if a resort takes last minute, discount bookings. Ideally, resort participants in the loyalty scheme of embodiments of the present invention do not offer such last minute discount bookings. Even if they do, the cash top-up amount paid by the customer under the present invention should be less that the last minute rates.

Once a resort has been identified as being a suitable resort partner in the loyalty scheme, the scheme provider makes contact with the resort. This typically occurs by way of email or normal mail. An explanation as to the benefits of the scheme to the resort is also provided, such as in the form of a brochure.

If an identified potential resort partner expresses interest in joining the loyalty scheme, the scheme provider then negotiates with the resort to become a resort partner. The negotiations may include the following:
the rate at which the accommodation is provided;
the number of rooms provided;
the availability dates for the rooms;
the basis on which the rooms are made available to the service provider (for example, the rooms may be made available on allotment, free-sell or request only basis); and
other contractual details.

Once all of the details are negotiated, appropriate contracts between the scheme provider and the resorts are finalised and executed. Details of each resort who become resort participants in the scheme are then entered onto a computer system, such as a spreadsheet or a database.

In addition to being able to sell distressed inventory at a rate that does not appear to be a discount rate, the accommodation providers also stand to gain from participation in the scheme in the following ways:
a) the accommodation providers have access to cobranding with the third party promotion provider (such as a retail outlet) in marketing material,
b) the accommodation providers have access to extensive brand exposure through participants catalogues and marketing and advertising material at no cost.
c) Incremental distribution as value of offers actually increases travel in general to those that may not have traveled.
d) No longer competing for discretionary dollars as customers can do both.
e) the accommodation providers also have the ability to sell excess capacity a long way (for example, up to 12 months) in advance whereas traditional last minute sites only sell within 28 days.

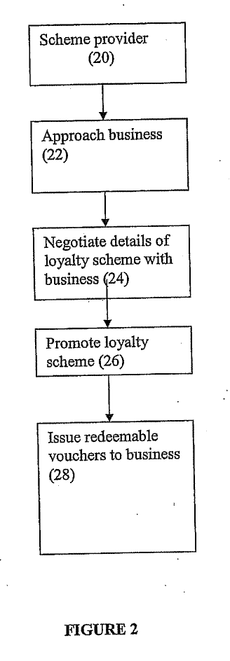

The participation of resort partners in the loyalty scheme described with reference to the embodiment shown in FIGS. 1 to 4, represents only part of the overall scheme. It is also necessary to have one or more business partners involved in the scheme. FIG. 2 shows one possible flow chart for obtaining loyalty partners to the scheme. In FIG. 2, the scheme provider 20 approaches a business, at step 22. The business may, for example, be a retailer of goods. However, it will be understood that the business may be any business that provides goods or services to customers or clients for profit or revenue.

Once the approach has been made by the scheme provider to the business, the scheme provider and the business negotiate various details of the loyalty scheme with the business. Some of the details that may be negotiated at step 24 include payments made by the business to the scheme provider for participation in the loyalty scheme, the spending of customers required at which customers are rewarded with issuance of redeemable vouchers, details of advertising and promotion of the scheme, details of the resort partners to the scheme, expiry date on the rewards vouchers, and the like.

Once the scheme provider and the business have fully negotiated the terms of the business partner's participation in the scheme, appropriate contractual arrangements are finalised and executed. Promotion of the loyalty scheme (at 26) and the issuance of redeemable vouchers to the business partner (at step 28) then follow. It will be appreciated that steps 26 and 28 may be conducted in any order or at the same time. Suitably, promotion of the loyalty scheme also includes promotion and advertisement of the accommodation providers. This also acts as a further incentive for accommodation providers to participate in the scheme.

Promotion of the loyalty scheme by the business may involve placement of advertisements for the resort partners into advertising material prepared by or for the business partner. This has the beneficial affects of enticing potential customers of the business to spend money with the business and also provides a further avenue of advertising for the resort partners.

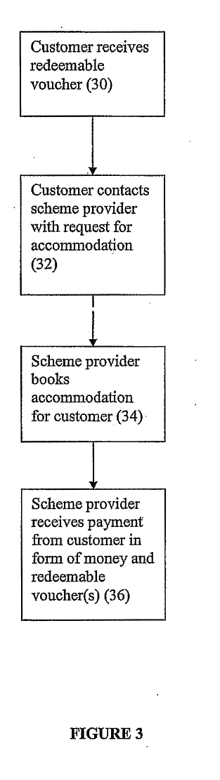

FIG. 3 provides a flow chart showing one possible way of redeeming accommodation in accordance with an embodiment of the present invention. In FIG. 3, a customer who has received redeemable vouchers by virtue of purchasing goods or services from a business participant in the loyalty scheme decides that he/she wishes to book some accommodation. The customer contacts the scheme provider and lodges an accommodation request with the scheme provider (see step 32). The customer may contact the scheme provider with the accommodation request in a number of ways, including by telephone, by mail, by email, by the internet, by facsimile, or indeed in any other suitable manner. In one embodiment, the customer makes an accommodation booking by filling in an electronic form on the internet, which form is then received by the scheme provider. The electronic form may be received by the scheme provider by way of an email automatically generated by a “submit” button on the electronic form, or by way of direct transfer of information from the form to the scheme provider when a “submit” button on the form is pressed. When the scheme provider receives the accommodation request from the customer, the scheme provider checks room availability and room rate with the accommodation provider and then books the accommodation for the customer. The accommodation may be booked by the scheme provider by way of the internet, by way of email, by way of telephone call, by way of letter or by way of facsimile.

The scheme provider also advises the customer of the amount of money to be paid and the amount of rewards vouchers to be redeemed. The scheme provider then receives appropriate payment from the customer (at step 36), by way of recordal of redeemable vouchers being used and cash/credit card/cheque payment. Suitably, the scheme provider also pays the resort at the time of making the booking or before the guests check-in. Typically, other distribution channels pay after the guests check-in. For example, wholesalers and travel agents pay up to 60 days after check-in. This is a further attractive feature of some embodiments of the present invention for the resort participants. In this regard, it will be appreciated that resorts typically receive full payment only upon check-in by the guest whereas in these embodiments of the invention the resort receives payment upon booking. The scheme provider also records details of the redeemable vouchers used in the booking.

The scheme provider suitably provides a booking confirmation that is sent to the customer. This booking confirmation may be computer generated. The booking confirmation may be sent to the customer by email or via the internet. The scheme provider may also require the accommodation provider to provide a booking confirmation prior to issuing the booking confirmation to the customer.

In another embodiment, the scheme provider may provide an online booking site. This online booking site may enable the accommodation provider to input or enter inventory, such as vacancies, onto the online booking site. The customer will then be able to book the accommodation using their resort cheques or reward vouchers or reward credits and to pay the money component online. The online system will then check that the reward cheques or reward vouchers or reward credits are valid. The payment then go to the scheme provider whilst a booking confirmation goes to the accommodation provider. Confirmation of the booking is then sent back to the customer. The online booking site may comprise a booking site on the internet or on the world wide web.

In other embodiments, the customer may book directly with the accommodation provider, for example, by accessing an online site (such as available on the world wide web or internet) or by telephone, email or conventional mail. The customer will be required to provide details of the reward vouchers or credits being redeemed, which details are then passed onto the scheme provider for checking, confirmation and reconciliation. Advantageously, in embodiments where the customer makes a booking via the internet or world wide web, the booking site asks the customers for details of the rewards vouchers or credits being redeemed and those details are automatically sent to the scheme provider for checking, confirmation back to the accommodation provider that the rewards vouchers/credits are valid and reconciliation of the redeemed vouchers/credits (for example, to show that a voucher has been used or to reconcile a customer's reward account). Advantageously, in this embodiment, the details are sent from the booking site to the scheme provide by the background computer programme without requiring operator input.

In some embodiments of the present invention, there may be a maximum amount of redeemable vouchers that may be used in the booking of accommodation. This ensures that a customer booking accommodation must use a minimum amount of real money to book the accommodation. Suitably, the minimum amount of real money required to book accommodation is at least equal to the rate at which the scheme provider obtains that accommodation from the accommodation provider.

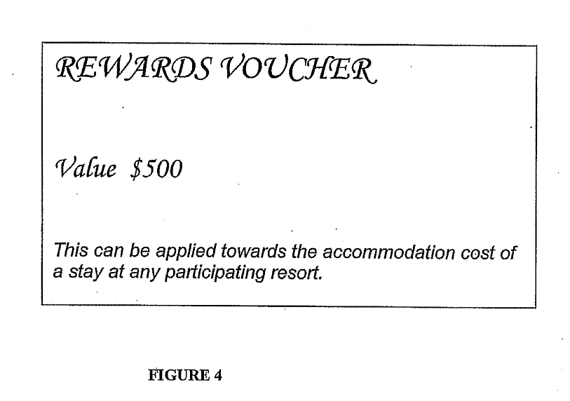

FIG. 4 shows a sample of a rewards voucher that may be issued in accordance with embodiments of the present invention. As can be seen from FIG. 4, the rewards voucher has a face value of $500 that can be applied towards the accommodation cost of a stay at any participating resort. As an alternative to calling the redeemable credit a rewards voucher, the redeemable credit may be in the form of a “rewards cheque” or a “resort cheque” made out to the favour of the scheme provider.

The scheme provider may derive income from operating the scheme in the following manner:
(a) the scheme provider may be provided with payments or commission from the business partners, with the payment or commission being dependent upon the total amount of the face value of all rewards vouchers issued;
(b) the scheme provider may be paid commission by the resort participants for all accommodation bookings made through the scheme;
(c) the scheme provider may receive the real money component of the accommodation payment from customers in an amount that is higher than the rate at which the accommodation has been booked from the resort participants; or
(d) the scheme provider may charge a fixed fee, or a design fee, or a printing fee, or two or more of those fees.

As a further benefit to all participants in the scheme, the rewards vouchers do not form a liability on the balance of the scheme provider. This is because redemption of the rewards vouchers actually represents an income stream for the scheme provider.

The scheme is attractive to customers of the business because they can instantaneously obtain rewards vouchers by simply spending a qualifying amount. There is no need to accumulate loyalty points over a period of time, as is common with most loyalty programs.

In another embodiment, the customer of the business may be required to provide various details to the business at the time the rewards vouchers are issued to the customer. In this way, the business can readily collect customer information. This may allow for more targeted marketing activities by the business to those customers in the future. It also enables the business to collate a database of customer information.

If booking of accommodation does not result in the entirety of a rewards voucher from being expended, it may be possible to issue a credit voucher to the customer for the unused portion of the rewards voucher.

In another embodiment, instead of collecting vouchers, a “rewards account” may be opened for each customer, with the rewards account having redeemable credits added thereto as spending of the customer with the business participant continues or increases. The rewards account may contain a balance in the form of a nominal money value of redeemable credits. The rewards account may be kept on a computer system. The rewards account may be accessed via a computer network, such as the internet. Appropriate security protocols may be enacted on the rewards account to prevent unauthorized access. Use of the rewards currency value in the rewards account to make a booking results in that amount being deducted from the rewards account balance.

In another embodiment, a customer may be provided with a smart card, which smart card contains information relating to a rewards account.

Although the various preferred embodiments of the present invention have been described with reference to redeeming accommodation, it will be appreciated that other goods or services may be redeemed. Examples include day pass services, four wheel drive tours, reef tours, cruises, short hall international holidays, “distressed inventory” goods, and the like.

Suitably, the redeemable credits have a nominal face value in monetary terms or dollar terms. In this fashion, the face value or monetary value of the redeemable credits can be used to maintain price integrity of the goods or services offered to customers under the loyalty scheme. Thus, the redeemable credits may be considered to be a “rewards currency” or a “rewards cheque”.

The scheme provider may also operate computer programmes that manage the loyalty scheme. The computer programmes may be stored on recordable media, such as CD, CD-ROM, DVD, one or more hard disk drives, and the like.

Those skilled in the art will appreciate that the present invention may be susceptible to variations and modifications other than those specifically described. It is to be understood that the present invention encompasses all such variations and modifications that fall within its spirit and scope.

The claims defining the invention are as follows:

1. A method for providing goods or services to a customer of a business comprising:
a) approaching a plurality of suppliers of goods or services;
b) securing a reduced rate with each supplier of the plurality of suppliers for the supply of goods or services;
c) recording details of the suppliers and the rates at which the suppliers supply goods or services;
d) issuing redeemable credits to a customer of the business, the redeemable credits having a face value equivalent to a predetermined cash value; and
e) arranging supply of goods or services from one or more of the plurality of suppliers to the customer, the supply of goods or services being paid for by the customer by using a combination of money and the redeemable credits.

2. A method as claimed in claim 1 wherein the plurality of suppliers of goods or services comprise suppliers of accommodation services.

3. A method as claimed in claim 2 wherein the accommodation services are secured at a rate that is lower than the cheapest advertised rate available in the market through the supplier's distribution channels for each of the suppliers of the accommodation services.

4. A method as claimed in claim 2 wherein the supply of the accommodation to a customer of the business requires payment in money of at least the reduced rate and redemption of some of the redeemable credits that they have obtained by virtue of their custom at the business.

5. A method as claimed in claim 1 wherein the redeemable credits bear a monetary face value.

6. A method as claimed in claim 1 wherein the customer obtains the redeemable credits by purchasing goods or services from the business.

7. A method as claimed in claim 6 wherein the redeemable credits are obtained by spending in excess of a predetermined minimum amount with the business.

8. A method as claimed in claim 1 wherein a third entity negotiates and secures the reduced rate with each supplier for the supply of goods or services.

9. A method as claimed in claim 8 wherein the third entity also negotiates with the business to provide the redeemable credits for customers of the business.

10. A method as claimed in claim 9 wherein the third entity undertakes the following actions
Negotiate the reduced rate for the supply of goods or services with the suppliers of the goods or services;
Complete contractual arrangements with the suppliers of the goods or services for supplying the goods or services at the reduced rate;
maintaining records of the suppliers of the goods or services, the quantity of the goods or services available to be supplied from each supplier, and the rate or dollar value for provision of the goods or services;
negotiate with the business for an appropriate scheme for issuing the redeemable credits.

11. A method as claimed in claim 1 further including the steps of promoting or advertising the redeemable credits being obtainable by customers purchasing goods or services/spending money with the business.

12. A method as claimed in claim 8 wherein the third entity generates income from one or more of the following:
(a) by receiving a payment from the business equivalent to a percentage of the redeemable value of the redeemable credits given by the business to its customers; or
(b) receiving a payment from the suppliers of the goods or services for supply of those goods or services to customers of the business;
(c) by the third entity including a mark-up in the amount of real money that a customer must use to obtain supply of the goods or services or
(d) by the third entity charging one or more of a fixed fee, a design fee or a printing fee.

13. A method as claimed in claim 8 wherein the third entity enters into contracts with suppliers that do not normally discount their rates.

14. A method as claimed in claim 8 wherein the third entity enters into pricing integrity agreements with the suppliers of the goods or services such that the supplier of the goods or services cannot provide discounted rates except in conjunction with the third entity.

15. A loyalty rewards scheme in which a scheme provider secures a reduced rate for supplying goods or services from suppliers of goods or services; the scheme provider secures a business as a participant in the loyalty rewards scheme and the scheme is arranged such that a customer of the business obtains redeemable credits from the business when the customer purchases goods or services from the business in excess of a predetermined minimum amount, wherein the customer obtains goods or services from one or more of the suppliers and pays for those goods or services by a combination of money and redeemable credits.

16. A loyalty rewards scheme as claimed in claim 15 wherein the goods or services supplied by the suppliers of goods or services represent excess goods or excess service capacity.

17. A loyalty rewards scheme as claimed in claim 15 wherein the redeemable credits have a face value equivalent to a monetary value.

18. A system for managing a rewards loyalty scheme as claimed in claim 15, the system comprising a computer storage means for recording details of suppliers of goods or services under the loyalty rewards scheme, the computer storage means recording at least the rate at which the supplier suppliers goods or services and the availability of goods or services from the supplier, and a register for recording redemption of the redeemable credits.

19. A system as claimed in claim 18 wherein the register for recording redemption of the redeemable credits forms part of the computer storage means.

20. A system as claimed in claim 18 further including an issue register for recording issue of the redeemable credits.

21. A system as claimed in claim 20 wherein the issue register records details of the customer and the amount of redeemable credits issued to the customer.

22. A system as claimed in claim 21 wherein the issue register allows for accumulation of redeemable credits.

23. A system as claimed in claim 18 wherein the system includes a facility adapted to enable a customer to redeem credits and book online or enquire about a booking online.

24. A system as claimed in claim 18 wherein the system includes a facility whereby suppliers can enter their own details about availability of their goods and services for access via the internet or the world wide web.
